(19) United States
(12) Patent Application Publication
(10) Pub. No.: US 2009/0235083 A1
(43) Pub. Date: Sep. 17, 2009

(54) SYSTEM AND METHOD FOR PREVENTING UNAUTHORIZED ACCESS TO INFORMATION

(76) Inventor: Micheal Bleahen, Dublin (IE)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/390,049

(22) Filed: Feb. 20, 2009

Related U.S. Application Data
(60) Provisional application No. 61/030,003, filed on Feb. 20, 2008.
(60) Provisional application No. 61/081,523, filed on Jul. 17, 2008.
(60) Provisional application No. 61/153,062, filed on Feb. 17, 2009.

(51) Int. Cl. H04L 9/32; G06F 12/14

(52) U.S. Cl. 713/178; 713/193

(57) ABSTRACT

An authentication system protects a hardware cryptographic chip from being commanded to decrypt or sign data by someone other than the legitimate owner(s) of the certificate residing on the chip. Openness of present cryptographic hardware systems are limited by imposing a condition that the cryptographic chip will only perform critical cryptographic tasks if the task is accompanied by a signed time-stamped transaction identifier which only the legitimate owner of the chip can provide.

### CROSS REFERENCE TO RELATED APPLICATION

The present invention claims priority to U.S. Provisional Patent Application 61/030,003 filed on Feb. 20, 2008 which is incorporated by reference it its entirety, U.S. Provisional Patent Application 61/081,523 filed on Jul. 17, 2008 which is incorporated by reference it its entirety, and U.S. Provisional Patent Application 61/153,062 filed on Feb. 17, 2009 which is incorporated by reference it its entirety.

### FIELD OF THE INVENTION

The present invention is related to computer security, and more particularly to a system and method for user authentication.

### BACKGROUND OF THE INVENTION

Hardware cryptography has an enormous weakness in that the cryptographic chip will perform critical cryptographic tasks as long as the task is accompanied by the password of the certificate residing on the chip.

The problem is that a ‘hacker or virus/trojan’ having a ‘key logger’ can trap the users ‘key strokes’, grabbing the user's password and—unseen by the user—command the chip to decrypt and/or sign data.

The problem, as stated above, is that the cryptographic chip is ‘open’ to an application which can supply the password—including nefarious applications. It's important in hardware cryptography that the system be open, placing as few restrictions on legitimate users as possible. However in it's present state, hardware cryptography is too open.

Hardware cryptography uses two cryptographic libraries; PKCS#11 and the CryptoAPI. These cryptographic libraries allow developers of hardware cryptographic solutions to rapidly develop applications without needing to know anything about the underlying hardware. Additionally; these two libraries are almost a ‘standard’ in cryptography and as such there is enormous resistance to any changes to these libraries.

These two libraries mentioned are also used by the CryptoChip and have an enormous weakness called ‘Silent-Mode Login’, which allows an application to supply the password to the Smart Card or CryptoChip.

The problem with ‘Silent-Mode login’ is that a ‘trojan’ application having a ‘key logger’ can trap the users ‘key strokes’, grabbing the user's password and—unseen by the user—command the Smart Card or CryptoChip to decrypt and/or sign data and at some future time send that data from the computer.

The inherent weakness of ‘Silent-Mode Login’ is known to the Smart Card industry but is regarded as an acceptable risk for the following reason: In the absence of ‘Silent-Mode Login’, the user would be required to frequently supply the password for critical tasks such as ‘decryption & message signing’, leading to user irritation and a rejection of Smart Card technology.

A properly working PKI system depends on a user's private key remaining private. While Smart Cards make it impossible to steal a user's private key, the weakness of Silent-Mode Login means that while it may not be possible to steal a private key, it is possible to utilize a private key, thus undermining confidence in such a system.

### SUMMARY OF THE INVENTION

The present invention provides a system and method for protecting a hardware cryptographic chip from being commanded to decrypt or sign data by someone other than the legitimate owner(s) of the certificate residing on the chip. Illustrative embodiments of the present invention limit the ‘openness’ of present cryptographic hardware systems by imposing a condition that the cryptographic chip will only perform critical cryptographic tasks if the task is accompanied by a ‘signed time-stamped transactionID’, which only the legitimate owner of the chip can provide, instead of the password used today.

An illustrative embodiment of the invention provides a method of securing data storage hardware. The method includes the steps of obtaining a time-stamped transactionID from a cryptographic device, sending the time-stamped transactionID to the data storage hardware and obtaining therefrom a time-stamped transactionID signature. The method further includes the steps of providing access to the data storage hardware, sending the time-stamped transactionID signature with data to the cryptographic device, the cryptographic device creating a second time-stamped transactionID as a function of an identifier of the cryptographic device, and comparing the time-stamped transactionID from the cryptographic device with the second time-stamped transactionID. If the time-stamped transactionID from the cryptographic device matches the second time-stamped transactionID, then cryptographic service is provided on the data.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a system diagram of an authentication system and process according to an illustrative embodiment of the invention;

FIG. 2 is a system diagram of an authentication system and process according to an illustrative embodiment of the invention;

FIG. 3 is a system diagram of an authentication system and process according to an illustrative embodiment of the invention;

FIG. 4 is a system diagram of an authentication system and process according to an illustrative embodiment of the invention;

FIG. 5 is a system diagram of an authentication system and process according to an illustrative embodiment of the invention;

FIG. 6 is a system diagram of an authentication system and process according to an illustrative embodiment of the invention; and

FIG. 7 is a pictorial view of a smart card having a display window as used in an illustrative embodiment of the invention.

### DETAILED DESCRIPTION

Illustrative embodiments of the invention exclude unauthorized execution of the CryptoChip by demanding that cryptographic requests be accompanied by the signature of a time-stamped transactionID, Furthermore the illustrative embodiments require that the signature be provided by a Smart Card having 1) a copy of the public/private keypair from the CryptoChip in which only 2) the PKCS#11 library has been implemented and 3) on which silent-mode login switched off.

By requiring a Smart Card with a copy of the CryptoChip public/private keypair, this embodiment enables us to produce a signature which will be a copy of the signature produced by the CryptoChip—and more importantly exclude processes which can't provide that signature. By requiring that only the PKCS#11 library has been implemented, because the PKCS#11 is session-based, an application only has to authenticate at the beginning of a session and unlike the CryptoAPI doesn't have to re-authenticate. And, by requiring that silent-mode login is switched off, the Smart Card will not begin a cryptographic session unless the user clicks ‘OK’ or provides a password. This ‘user interaction’ is something which a hacker or a virus/trojan cannot do—it's not possible.

The use of a Smart Card is the 1^{st} factor of authentication. In addition, the user interaction required by the illustrative embodiments of the invention, which cannot be simulated by a hacker or virus/Trojan, is the 2^{nd} factor of authentication.

When the CryptoChip is initialized, a ‘CryptoChip Certificate’ is created. Each user of the CryptoChip is issued a certificate containing the public/private keypair from the ‘CryptoChip Certificate’ and individualized ‘Distinguished Name’ details. These ‘user certificates’ are stored on a Smart Card only having implemented PKCS#11 and having silent-mode login disabled. The Smart Card allows data to signed with a signature will be the same as a signature created by the CryptoChip. This allows for the maintenance of distinct accounts on the CryptoChip and a method of authenticating each request to the CryptoChip.

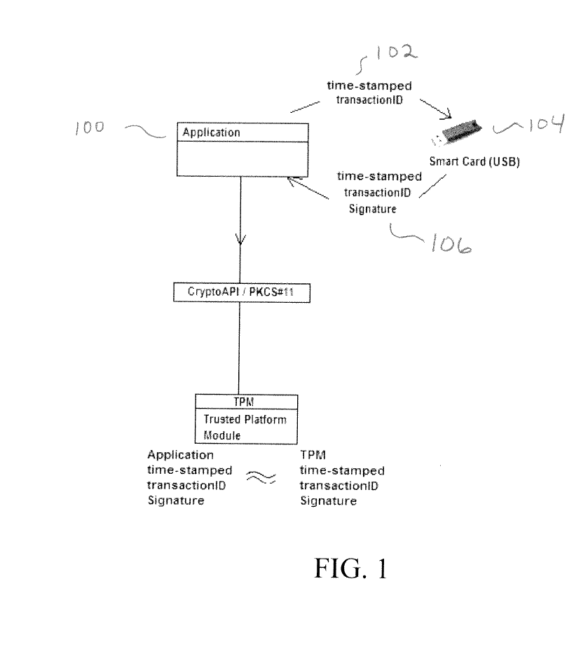

An illustrative authentication method according to an embodiment of the present invention is described with reference to FIG. 1. When an application 100 needs a cryptographic service it first must obtain a ‘time-stamped transactionID’ 102 from the CryptoChip. The application then sends the ‘time-stamped transactionID’ to the Smart Card 104 where it is signed. If this is the first time the application has used the Smart Card, then the Smart Card will require the user to authorize the session, by clicking ‘OK’ or entering a password, for example, because ‘silent-mode login’ has been disabled on the Smart Card and only PKCS#11 has been implemented on the Smart Card. The application then sends the ‘time-stamped transactionID signature’ 106 with the data to the CryptoChip. The CryptoChip takes the ‘time-stamped transactionID’ it produced earlier for the application and signs it with the CryptoChip certificate. The CryptoChip compares the two signatures. If they are equal the cryptographic service is performed. Otherwise the cryptographic service is not performed.

In another embodiment of the invention, a trojan threat to CryptoChips can be nullified by using a Smart Card which provides a second factor of authentication and a ‘signed synchronised dynamic transactionID’. In this embodiment, the CryptoChip will only execute commands when the command is accompanied by a ‘transactionID signature’, thus avoiding impersonation, where the signature is provided by the Smart Card. Each user of the CryptoChip is issued a certificate containing the public/private keypair from the ‘CryptoChip Certificate’ and individualized ‘Distinguished Name’ details. This allows the maintenance of distinct accounts on the CryptoChip. New users can only be created by an existing user and a newly created user certificate is stored on a Smart Card, only implementing the PKCS#11 library—thus benefiting from ‘sessions’—on which ‘Silent-Mode Login’ has been disabled.

Embodiments of the invention use a set of synchronized ‘Random Number Generators’ (RNG's) or other synchronizable function between the CryptoChip on the one hand and the ‘Crypto Corn Object’ on the other. The Seed and Counter are passed from the CryptoChip to the ‘Crypto Corn Object’ when the computer is started-up and both are used to initialize synchronized RNG's on the CryptoChip and the CCO. This allows the creation of synchronised transactionID's. The Smart Card signs the transactionID. This ‘signed transactionID’ is passed by the application to the CryptoChip—through the CryptoAPI. The CryptoChip ‘transactionID’ is signed and the ‘signed transactionID’ is compared to the ‘signed transactionID’ accompanying a ‘cryptographic command’. Only commands satisfying this ‘signature comparison’ are executed. This tightly limits access to the CryptoChip to Smart Cards holding a clone of the ‘Crypto Certificate’.

Two important aspects of the above embodiments which protect against an attack by a trojan/virus or a hacker are, first, only implementing the PKCS#11 library on the Smart Card on which ‘Silent-Mode login’ has been disabled, and second, signing the transactionID.

The first important aspect, only implementing the PKCS#11 library on the Smart Card on which ‘Silent-Mode Login’ has been disabled is effective because the PKCS#11 library, unlike the CryptoAPI, is session based. As such, applications needing to utilize the Smart Card only have to pass the ‘password’ of the Smart Card once. With ‘Silent-Mode Login’ disabled, the user is required to interact before allowing the session to begin. This puts the user totally in control of sessions which start on the Smart Card. More than one application can use the Smart Card, but each application requires the user to interact once before the session will begin. This is something a trojan/virus or hacker cannot do.

The second important aspect, ‘signing the transactionID’ before commands will execute on the CryptoChip is effective because the Smart Card must be used, but only sessions ‘interacted once’ by the user are started on the Smart Card. This is also something a trojan virus or hacker cannot do.

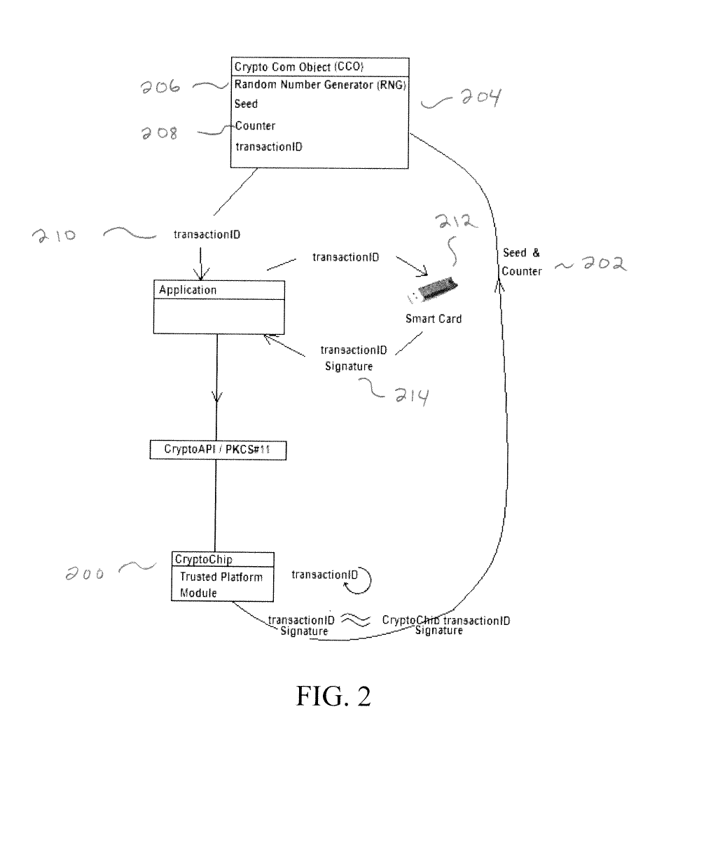

Another illustrative embodiment of the invention is described with reference to the process of FIG. 2. When a computer is switched on the CryptoChip 200 sends ‘Seed and Counter’ values 202 to the Crypto Corn Object (CCO) 204. An object of this embodiment is to synchronize a Random Number Generator (RNG) 206 of the CCO with an RNG (not shown) of the CryptoChip 200. This is achieved by seeding the RNG of the CCO and the CryptoChip's with the Seed and cycling them Counter 208 times. The output from the CCO's RNG is a ‘dynamic transactionID’ 210 which should now be synchronized with the RNG on the CryptoChip, except being 1 cycle ahead. The dynamic transactionID 210 is sent to a Smart Card 212 where it is signed. This ‘signed transactionID’ 214 is passed from the application through the ‘PKCS#11/CryptoAPI’ libraries, to the CryptoChip 200. The CryptoChip 200 only executes commands when the command is accompanied by a ‘transactionID signature’, thus avoiding impersonation.

The CryptoChip cycles its RNG once to produce the ‘CryptoChip transactionID’. The CryptoChip signs the ‘CryptoChip transactionID’ with the CryptoChip certificate before it compares the signature to the signature of the ‘CCO transactionID’. If they are identical the operation is processed the data is decrypted/signed.

If a ‘transactionID Number’ could be coupled with the ‘signed transactionID’ asynchronous execution would be possible. The CCO would have to guard against ‘Remote Desktop’ and virtual execution.

Another embodiment of the invention uses a set of synchronized ‘Random Number Generators’ (RNG's) between the CryptoChip on the one hand and the ‘Crypto Corn Object’ on the other. When the CryptoChip is first used a ‘CryptoChip Certificate’ is created and stored on the CryptoChip. The CryptoChip RNG is seeded and cycled ‘Counter’ times. Finally the Seed and Counter are encrypted using the ‘CryptoChip Certificate’ and passed to the CCO after initialization or when the computer is started-up.

Each user of the CryptoChip is issued a certificate containing the public/private keypair from the ‘CryptoChip Certificate’ and individualized ‘Distinguished Name’ details. This allows all users access to the eSeed & eCounter and yet maintain distinct accounts on the CryptoChip. New users can only be created by an existing user and a newly created user certificate is stored on a Smart Card, having just the PKCS#11 library, on which ‘Silent-Mode Login’ has been disabled. When the computer is switched on, the ‘Crypto Corn Object’ is started. If the CryptoChip has been initialized, then the CryptoChip passes the eSeed, the eCounter and the public key of the computer certificate to the Crypto Corn Object.

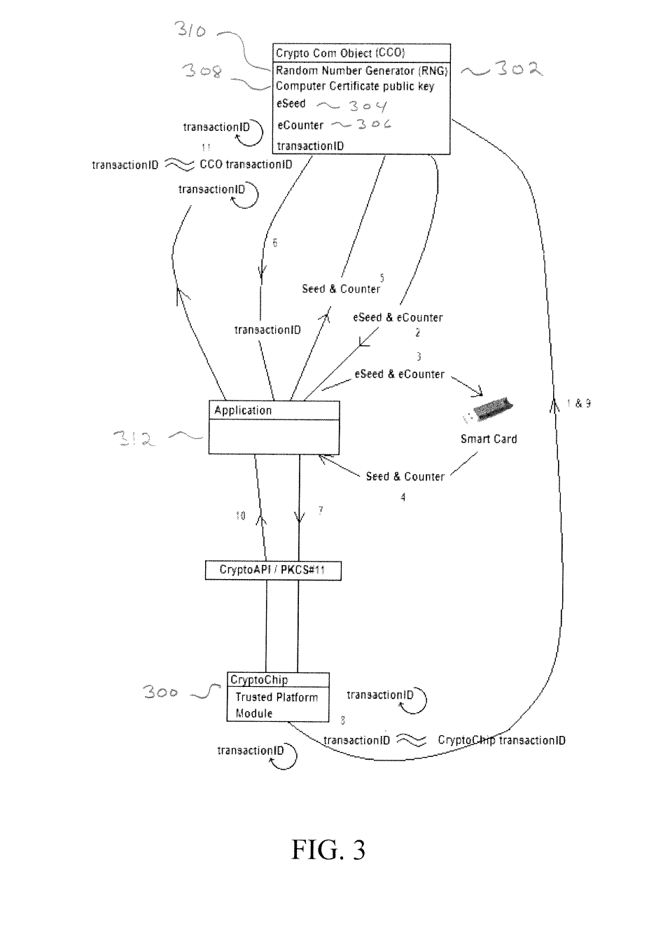

An illustrative process according to this embodiment is described with reference to FIG. 3. When a computer is switched on, the CryptoChip 300 sends the eSeed 304, the eCounter 306 and The Computer Certificate public key 308 to the Crypto Corn Object (CCO). An object of this step is to synchronize the Random Number Generator (RNG) 310 of the CCO 302 with the RNG (not shown) or the CryptoChip 300. This is achieved by seeding the RNG 310 of the CCO 302 with the decrypted eSeed (Seed) and cycling the RNG 310 Counter times. The eSeed 304 and eCounter 306 are made publicly available to applications needing to utilize the CryptoChip 300.

Because the Counter increases in defined steps, i.e., it increases by 2 every time the CryptoChip performs a private key operation, the Counter can be used to crack the private key of the Computer Certificate. For this reason, the eCounter 306 isn't directly available to applications needing to utilize the CryptoChip. Instead the eCounter is only made available to a computer application which returns a signature of the eSeed 304 to the CCO 302. On receipt of the signature of the eSeed 304, the CCO 302 attempts to verify the signature with the public key of the Computer Certificate and if it verifies the signature then the CCO 302 releases the eCounter 306 to the computer application 312. The CCO is locked and subsequent calls are queued.

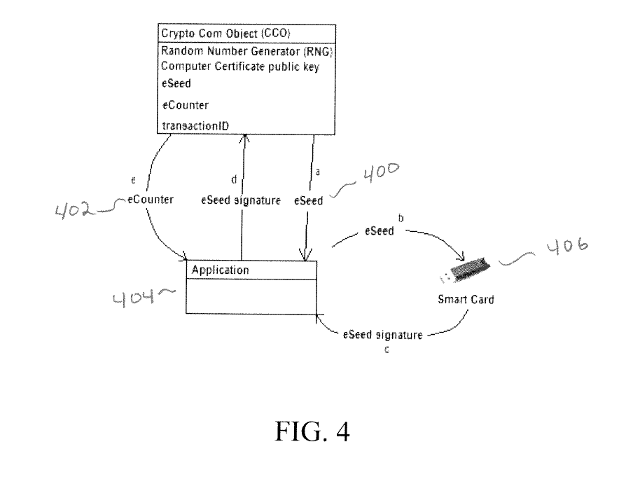

Once the eSeed 400 and eCounter 402 have been acquired by the application 404, they are sent by the application 404 to the Smart Card 406 where they are decrypted. The certificate on the Smart Card shares the same public/private key pair as the computer certificate on the CryptoChip. Referring to FIG. 4, first, the decrypted seed and counter are returned to the application. The seed and counter are then sent from the computer application to the CCO where the seed is used to seed the CCO's Random Number Generator. The RNG is cycled ‘Counter+1’ times. The output from the CCO's RNG is a ‘dynamic transactionID’ which should now be synchronized with the RNG on the CryptoChip, except being 1 cycle ahead. The dynamic transactionID is passed from the application, through the ‘PKCS#11/CryptoAPI’ libraries, to the CryptoChip. The CryptoChip cycles its RNG once before it compares the transactionID to the ‘CryptoChip transactionID’. If they the transactionID is identical to the CryptoChip transaction ID, the operation is processed wherein the data is decrypted/signed. The CryptoChip RNG is cycled one more time and the new transactionID is passed back to the application.

The CryptoChip updates the eCounter in the CCO, by adding ‘2’ to the previous Counter value before encrypting it. A signature of the eSeed must accompany the new eCounter. Only when the signature of the eSeed is verified by the CCO is the new value of the eCounter accepted. This process of signing the eSeed prevents rogue applications from overwriting the eCounter with bad values which would put the system out of synch. After the CCO's eCounter is overwritten the CCO is unlocked. Other applications can request the eSeed & eCounter as above in order to get the CryptoChip to perform ‘private key’ tasks. The new transactionID is passed back to the application, where it may be passed to the CCO if further ‘private key’ tasks are required.

Assuming that the next ‘private key’ task originates from the same application, the application passes the new transactionID to the CCO. The CCO cycles its RNG once and compares the result to the received transactionID. If they are identical, the CCO cycles its RNG once more to produce a new transactionID which is passed back to the application. The application passes this new transactionID, through the ‘PKCS#11/CryptoAPI’ libraries to the CryptoChip with the next ‘private key’ task. The transactionID, whether it is the one on the CryptoChip or the CCO is a private variable against which only comparisons are possible.

Another illustrative embodiment of the invention uses a set of synchronized ‘Random Number Generators’ (RNG's) between the CryptoChip on the one hand and the ‘Crypto Com Object’ on the other. When the CryptoChip is first used a ‘CryptoChip Certificate’ is created and stored on the CryptoChip. The CryptoChip RNG is seeded and cycled ‘Counter’ times. Finally the Seed and Counter are encrypted using the ‘CryptoChip Certificate’ and stored on the computer in a file called ‘Crypto.tID’. Each user of the CryptoChip is issued a certificate containing the public/private keypair from the ‘CryptoChip Certificate’ and individualized ‘Distinguished Name’ details. This allows all users access to the ‘Crypto.tID’ and yet maintain distinct accounts on the CryptoChip. New users can only be created by an existing user and a newly created user certificate is stored on a Smart Card, having just the PKCS#11 library, on which ‘Silent-Mode login’ has been disabled.

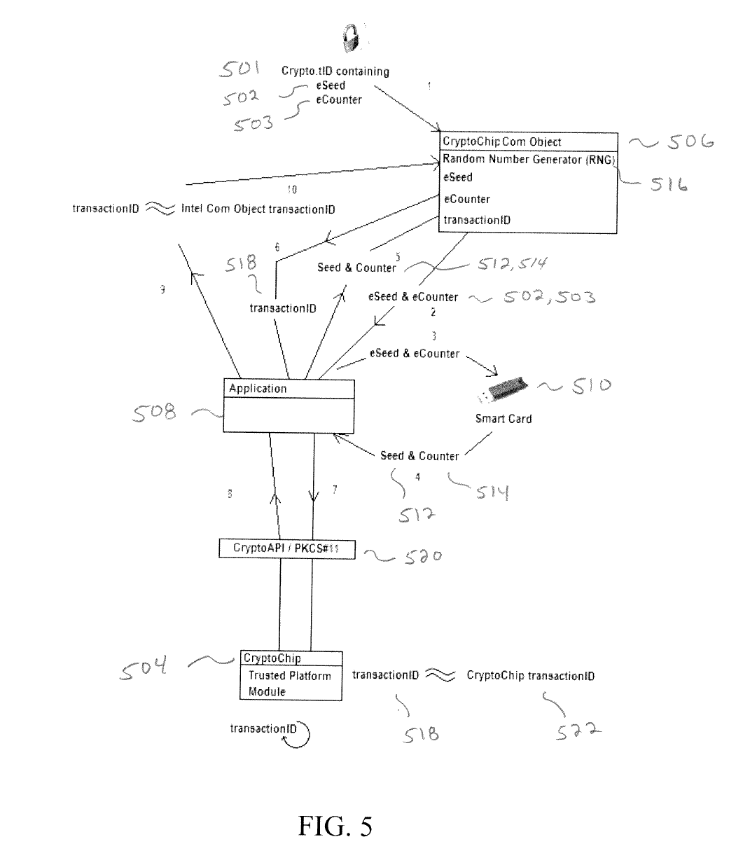

A process according to this illustrative embodiment is described with reference to FIG. 5. When the computer is switched on, the ‘CryptoChip Corn Object’ is started. If the CryptoChip has been initialized, then the CryptoChip Corn Object loads the ‘Crypto.tID’ 501, parses out the eSeed 502 and eCounter 503 and makes them available for applications wishing to utilize the CryptoChip. The crypto.tID 501 is loaded from a predefined location. The CCO 506 parses the crypto.tID 501 and obtains the eSeed 502 and eCounter 503. These are made publicly available to applications needing CryptoChip functionality.

A computer application 508 wishing to utilize the CryptoChip makes a request to the CCO 506 and obtains the eSeed 502 and eCounter 503. The CCO 506 is locked and subsequent calls are queued. The eSeed 502 and eCounter 503 are decrypted using the user's Smart Card 510. The seed 512 and counter 514 are sent from the computer application 508 to the CCO 506 where the seed 512 is used to seed the CCO's Random Number Generator 516. The RNG 516 is cycled ‘Counter’ 514 times. The output from the CCO's RNG 516 is a ‘dynamic transactionID’ which should now be synchronized with the RNG (not shown) on the CryptoChip 504.

The transactionID 518 is passed from the application, through the ‘PKCS#11/CryptoAPI’ libraries 520, to the CryptoChip 504. The CryptoChip 504 compares the transactionID 518 to the ‘CryptoChip transactionID’ 522. If they are identical, the operation is processed, the CryptoChip RNG is cycled once and the new transactionID is passed back application 508. The application increments the ‘Counter’ by one, encrypts the Counter to produce an eCounter, which it passes to the CCO 506 together with the new transactionID. The CCO cycles it's RNG 516 once, compares the result to the transactionID received from the application 508. If they are identical, then the CCO 506 overwrites the eCounter and releases the lock for the next queued request.

If the next queued request is coming from the same application as the previous request will know the current transactionID and place the CCO 506 in a locked-state by sending the current transactionID after which the steps above can be repeated after and including the step of passing the transaction ID 518 through the PKCS#11/CryptoAPI libraries 520 to the CryptoChip 504. If the next queued request is coming from a different application, then the process begins from step 1. The transactionID, whether it is the one on the CryptoChip or the CCO is a private variable against which only comparisons are possible.

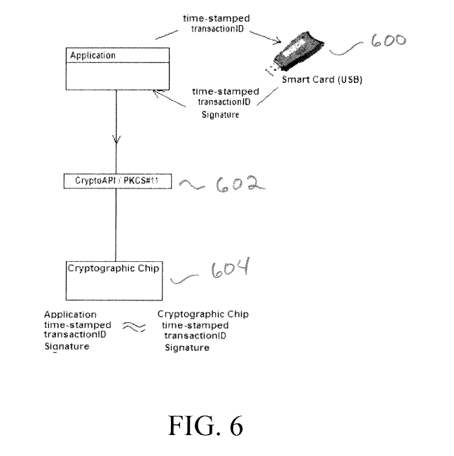

In another embodiment, instead of cryptographic tasks being accompanied by a password, the cryptographic task is accompanied by a ‘signed time-stamped transactionID’. This ‘signed time-stamped transactionID’ is acquired by a separate call to the cryptographic chip, prior to the request to perform a cryptographic task. This means that the previously ‘open’ system is now only open to users who can provide the necessary signature and is ‘closed’ to those who cannot provide a ‘signed time-stamped transactionID’. This embodiment is described with reference to the design shown in FIG. 6

In this embodiment, the public/private keypair on the Smart Card 600 certificate must be a copy of the public/private keypair on the cryptographic chip's certificate. Other certificate details like; name, address, etc, can be different, thus allowing for distinct accounts to be maintained. In this embodiment only the PKCS#11 library 602 has been implemented on the Smart Card 600 and ‘Silent mode login’ has been disabled on the PKCS#11 library 602. Further, the Smart Card 600 will only interact with the supplied PKCS#11 library 602 and will reject calls made by other copies of the PKCS#11 libraries.

Requiring a Smart Card 600 with a copy of the CryptoChip public/private keypair enables production of a signature which will be a copy of the signature produced by the chip and, more importantly, exclude processes which can't provide that signature. Additionally the certificate who's public/private keypair is shared between the smart card 600 and the cryptographic chip 604 is separate from the user's real certificate also residing on the cryptographic chip. Since the PKCS#11 is session-based, an application only has to authenticate at the beginning of a session and, unlike the CryptoAPI, it doesn't have to re-authenticate.

With silent-mode login switched off the Smart Card 600 will not begin a cryptographic session unless the user clicks ‘OK’ or provides a password. This ‘user interaction’ is something which a hacker or a virus/trojan cannot do. By requiring that the Smart Card 600 will only interact with the supplied PKCS#11 library 602, the enforced ‘user interaction’ arising from ‘silent mode login’ being switched of can be circumvented if the PKCS#11 dll can be replaced by another PKCS#11 dll on which ‘silent mode login’ is switched on. This circumvention can be avoided by hardening the link between the PKCS#11 dll and the smart card.

Hardening the link between the PKCS#11 dll and the smart card involves configuring the smart card to work with a specific dll. If another dll is used, then the smart card will not execute. This can be achieved by inserting a requirement between ‘Loading the Library’

HINSTANCE hPkcs11Lib=LoadLibrary(pkcs11_path);

And logging-in to the chip

pFncList->C_Login (hSes, CKU_USER, (CK_CHAR_PTR)Pwd, strlen(Pwd)))

After the application has loaded the smart card dll, the application creates a ‘hash’ of the loaded dll. This hash is passed to the smart card where it is compared to the hash of the dll, stored on the chip. If the hash doesn't compare, the user isn't allowed to login.

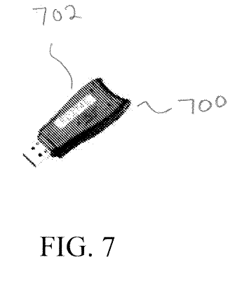

A problem with the above scenario is that a rogue application could load any dll which works with the smart card and sending the expected hash to the smart card. Thus circumventing authentication efforts. Referring to FIG. 7, a secure link can be achieved between the dll and the smart card 700 if the smart card has a visual output screen 702 showing 4-6 digits. The digits on the Smart Card screen can be concatenated to the binary of the dll. A hash of both can be calculated before being sent to the Smart Card. Each 4-6 digit combination produces a different hash. The smart card would similarly concatenate the output on it's screen with the binary of the dll, i.e., the binary of the dll is stored on the smart card, before calculating a hash of the combination. This hash is compared to the hash sent by the authenticating application. Authentication will only be complete if the hashes compare.

A hacker or virus/trojan cannot circumvent this authentication method because the hacker or virus/trojan has no way of reading the digits on the visual output screen 702 of the Smart Card 700. These digits do not pass through the computer and therefore they are inaccessible to a hacker or virus/Trojan.

The embodiments described herein, with reference to FIG. 6 and FIG. 7 have two kinds of certificate;
Normal Certificates
   These are certificates you use to communicate securely online with your Bank or Inland Revenue and which are stored on the TPM of one or more computers
Accessor Certificates
   Accessor certificates are stored on the Smart Card and are used to restrict access to your ‘Normal Certificates’. Accessor Certificates protect your Normal Certificates.

The following four processes according to various illustrative embodiments of the invention are described below in more detail: Authentication; Decrypting/Signing; Exporting an Accessor Certificate to the USB Smart Card; and Exporting a Normal Certificate to a USB memory stick.

### Authentication Process

Authentication is a two-step process, consisting of
The computer application authenticating with the USB Smart Card
The USB Smart Card authenticating with the TPM
   Importantly: to the user it appears as a single step.
1. In the application wishing to the authenticate, the user would selects the USB Smart Card containing the Accessor Certificate for this computer, from a list of available ‘USB Smart Cards’.
2. The user would then select the Accessor Certificate from the USB Smart Card.
3. The user enters two passwords
   a. A static password, which the user remembers—and blocks those with physical access to the Smart Card
   b. A ‘dynamic transactionID’ which the user reads from the VDU of the USB Smart Card—which is inaccessible to hackers or virus/trojan.
4. On completion of authentication with the USB Smart Card, a signature of the Accessor Certificate is returned to the application
5. The signature of the Accessor Certificate is sent to the TPM to authenticate the application.
6. The TPM verifies the signature of the Accessor Certificate from the USB Smart Card against all Accessor Certificates on the TPM.
7. If the signature doesn't verify, the user doesn't have a Normal Certificate stored on this TPM.
8. Otherwise authentication occurs and the user is presented with a list of Normal Certificates stored on this computer, one of which can be used to bank online.

### Decryption/Signing Process

1. When an application needs a cryptographic service it firstly must obtain a time-stamped transactionID from the cryptographic chip.
2. The application sends the ‘time-stamped transactionID’ to the Smart Card where it is signed.
3. If this is the 1^{st} time the application has used the Smart Card, then the Smart Card will require the user to authorize the session—by clicking ‘OK’ or entering a password—because ‘silent-mode login’ has been disabled on the Smart Card. Also; only PKCS#11 has been implemented on the Smart Card.
4. The application sends the ‘time-stamped transactionID signature’ with the data to the cryptographic chip.
5. The cryptographic chip takes the ‘time-stamped transactionID’ it produced earlier for the application and signs it with the cryptographic chip's certificate.
6. The cryptographic chip compares the two signatures. If they are equal the cryptographic service is performed. Otherwise the cryptographic service is not performed.

### Exporting the Accessor Certificate to the USB Smart Card Process

If the Accessor Certificate can be intercepted as it is being transferred from the TPM to the USB Smart Card the system is rendered useless. The Accessor Certificate can be safely exported to the USB Smart Card in the following way.
1. On instruction the USB Smart Card issues a public key—from a keypair generated temporarily for the purpose of importing an Accessor Certificate,
2. The application coordinating the transfer, takes the public key from the USB Smart Card and sends it to the TPM.
3. The TPM encrypts the Accessor Certificate—currently being used—with the public key.
4. The encrypted Accessor Certificate is passed back from the TPM to the application, which sends it on to the USB Smart Card.
5. The USB Smart Card decrypts the Accessor Certificate with the private key—from the keypair generated temporarily for the purposes of importing the Accessor Certificate.
6. The USB Smart Card adds the decrypted Accessor Certificate to it's list of certificates
   Nowhere in this scenario was it possible to get access to the keypair of Accessor Certificate

### Exporting a Normal Certificate to the USB Memory Stick Process

There will be times when you need a ‘Normal Certificate’ on a computer other than the one on which the certificate was created. An example would be if you normally did your online banking at work, but had a sudden need to do further work from home. You have created your online banking certificate on your work computer, where it is stored. Now you want to export that certificate from your work computer and take it to your home computer, where you would import the certificate into the TPM of your home computer.
Many Accessor Certificates can be stored on the same USB Smart Card. It's entirely possible to store the Accessor Certificate for your work PC and your home PC on the same USB Smart Card.
1. Use your USB Smart Card to authenticate to your work PC.
2. Once you're authenticated, select the ‘online banking’ certificate from your list of Normal Certificates stored on the TPM of your work PC.
3. Choose to ‘Export’ the certificate.
4. The certificate is encrypted with the public key of the ‘Accessor Certificate’ for your home PC—which is stored on the USB Smart Card, or another USB Smart Card.
5. You're instructed to connect your USB Memory Stick and the ‘encrypted certificate’ is written.
6. At home use your USB Smart Card to authenticate to your home PC.
7. Once you have authenticated and you select the ‘Import a Certificate’ feature, you are asked to set the path to the encrypted ‘online banking’ certificate on the USB Memory Stick.
8. Secondly you are required to select the ‘Accessor Certificate’—used to encrypt the ‘online banking’ certificate—from the USB Smart Card.
9. The ‘online banking’ certificate is imported into the TPM of your home PC in encrypted form. Remember that the ‘online banking’ certificate was encrypted by the Accessor certificate of your home PC and therefore can be decrypted by it's copy residing on the TPM of your home PC.
10. The certificate is saved to your ‘Normal Certificate’ list in the TPM of your home PC.

A properly working PKI system depends on a user's private key remaining private. While Smart Cards make it impossible to steal a user's private key, the weakness of a cryptographic chip performing a cryptographic task as long as it passes the correct password, means that while it may not be possible to steal a private key, it is possible to utilize a private key, thus undermining confidence in such a system.

Embodiments of the present invention may be performed by software or software and include hardware apparatus such as various microprocessor based devices, networks, general purpose computers and the like, such as persons having ordinary skill in the art would recognize for use in implementing the embodiments as described herein.

Although the present invention is described herein generally with reference to Smart Cards, persons having ordinary skill in the art should appreciate that the various embodiments of the invention are directed to cryptographic hardware, generally and are not limited particularly to Smart Cards or any specific type of cryptographic hardware.

While the invention has been described with reference to illustrative embodiments, it will be understood by those skilled in the art that various other changes, omissions, and/or additions may be made and substantial equivalents may be substituted for elements thereof with departing from the spirit and scope of the invention. In addition, many modifications may be made to adapt a particular situation or material to the teaching of the invention with departing from the scope thereof. Therefore, it is intended that the invention not be limited to the particular embodiment disclosed for carrying out this invention, but that the invention will include all embodiments, falling within the scope of the appended claims. Moreover, unless specifically stated any use of the terms first, second, etc., do not denote any order of importance, but rather the terms first, second, etc. are used to distinguish one element from another.

What is claimed is:

1. A method of securing data storage hardware, said method comprising the steps of:
obtaining a time-stamped transactionID from a cryptographic device;
sending the time-stamped transactionID to the data storage hardware and obtaining therefrom a time-stamped transactionID signature;
providing access to the data storage hardware;
sending the time-stamped transactionID signature with data to the cryptographic device said cryptographic device creating a second time-stamped transactionID as a function of an identifier of said cryptographic device;
comparing the time-stamped transactionID from the cryptographic device with the second time-stamped transactionID; and
providing cryptographic service on said data if the time-stamped transactionID from the cryptographic device matches the second time-stamped transactionID.
